(19) United States
(12) Patent Application Publication
(10) Pub. No.: US 2014/0140556 A1
(43) Pub. Date: May 22, 2014

(54) COVERED HOUSING

(71) Applicant: LOGITECH EUROPE S.A., Morges (CH)

(72) Inventors: David Yim, Vancouver, WA (US); Steve McGarry, Vancouver, WA (US)

(73) Assignee: Logitech Europe S.A., Morges (CH)

(21) Appl. No.: 13/682,565

(22) Filed: Nov. 20, 2012

(51) Int. Cl. H04R 1/02

(52) U.S. Cl. CPC H04R 1/021
USPC 381/332; 29/428

(57) ABSTRACT

One embodiment of the invention is directed to a process for assembly of a covered housing comprising placing a first frame strip coupled with a fabric portion, under a shoulder on a first end of a housing, pulling the fabric portion toward a second end of a housing, placing a second frame strip coupled with the fabric portion, under a shoulder on the second end of the housing, placing a third frame strip coupled with the fabric portion, under a first main body shoulder of the housing, and placing a fourth frame strip coupled with the fabric portion, under a second main body shoulder of the housing.

### BACKGROUND OF THE INVENTION

There are many challenges for assembling fabric to a unique shaped housing. If using a unique speaker housing shape, such as a cylinder shape, it is difficult to create tension in the fabric both vertically and horizontally around the cylindrical shaped component after the fabric is assembled to a cylindrical shape. The tension needs to be high enough so that the fabric cannot simply be pulled off the housing. Accordingly, a traditional sock assembly where a fabric sock that is open on both ends is slipped over a rectangular or cylinder housing would not work because the tension along the length of the sock cannot be well controlled. Moreover, a traditional sock assembly generally requires a cap on each end to mechanically hold the sock in place. If the cap also includes additional features or controls (e.g., buttons, etc.) or connectors, these may be damaged or compromised when applying pressure to fit the cap onto the housing. This creates additional challenges particularly for portable-type speakers that have limited space for controls. Other challenges include how to assemble one piece of fabric to substantially cover the speaker housing without cosmetic issues, such as seams and visible wrinkles

### BRIEF SUMMARY OF THE INVENTION

Embodiments of the invention are directed to a covered housing.

One embodiment of the invention is directed to a process for assembly of a covered housing comprising placing a first frame strip coupled with a fabric portion, under a shoulder on a first end of a housing, pulling the fabric portion toward a second end of a housing, placing a second frame strip coupled with the fabric portion, under a shoulder on the second end of the housing, placing a third frame strip coupled with the fabric portion, under a first main body shoulder of the housing, and placing a fourth frame strip coupled with the fabric portion, under a second main body shoulder of the housing.

Another embodiment of the invention is directed to a speaker comprising a speaker housing for housing speaker components therein. The speaker housing comprising a first end comprising a first shoulder. The speaker housing further comprising a second end comprising a second shoulder. The speaker housing further comprising a main body coupled with the first end and the second end, the main body comprising a first main body shoulder and a second main body shoulder. The speaker further comprising a fabric portion coupled with the speaker housing, the fabric portion comprising a first edge, a second edge, a third edge, and a fourth edge. The fabric portion further comprising a first frame strip coupled with the first edge, a second frame strip coupled with the second edge, a third frame strip coupled with the third edge, and a fourth frame strip coupled with the fourth edge. The fabric portion coupled with the speaker housing via the first frame strip of the fabric portion and the first shoulder of the speaker housing, the second frame strip of the fabric portion and the second shoulder of the speaker housing, the third frame strip of the fabric portion and the first main body shoulder of the speaker housing, and the fourth frame strip of the fabric portion and the second main body shoulder of the speaker housing.

Another embodiment of the invention is directed to a speaker comprising a speaker housing for housing speaker components therein. The speaker housing comprising a first end comprising a first fastening mechanism. The speaker housing further comprising a second end comprising a second fastening mechanism. The speaker housing further comprising a main body coupled with the first end and the second end, the main body comprising a first main body fastening mechanism and a second main body fastening mechanism. The speaker further comprising a fabric portion coupled with the speaker housing, the fabric portion comprising a first edge, a second edge, a third edge, and a fourth edge. The fabric portion further comprising a first frame strip coupled with the first edge, a second frame strip coupled with the second edge, a third frame strip coupled with the third edge, and a fourth frame strip coupled with the fourth edge. The fabric portion coupled with the speaker housing via the first frame strip of the fabric portion and the first fastening mechanism of the speaker housing, the second frame strip of the fabric portion and the second fastening mechanism of the speaker housing, the third frame strip of the fabric portion and the first main body fastening mechanism of the speaker housing, and the fourth frame strip of the fabric portion and the second main body fastening mechanism of the speaker housing.

These and other embodiments are described in further detail below.

### BRIEF DESCRIPTION OF THE DRAWINGS

FIG. 1A shows a flat version drawing of a fabric subassembly according to embodiments of the invention.

FIG. 1B shows a flat version drawing of a fabric subassembly according to embodiments of the invention.

FIG. 1C shows a flat version drawing of a fabric subassembly according to embodiments of the invention.

FIG. 2 shows a flat version drawing of a fabric subassembly according to embodiments of the invention.

FIG. 3 shows a drawing of a fabric layout with frame strips according to embodiments of the invention.

FIGS. 4-12 show drawings of a speaker fabric assembly.

FIGS. 13-21 show drawings of a covered housing.

### DETAILED DESCRIPTION OF THE INVENTION

Embodiments of the invention provide a covered housing that allows fabric to be wrapped around a speaker housing in a way to reach the desired tension. A speaker fabric assembly contains frame strips bonded to the fabric that may be tucked under shoulders of a speaker housing. Once the fabric strips are secured under the shoulders, the fabric is held in tension thereby holding the fabric in the intended position and shape.

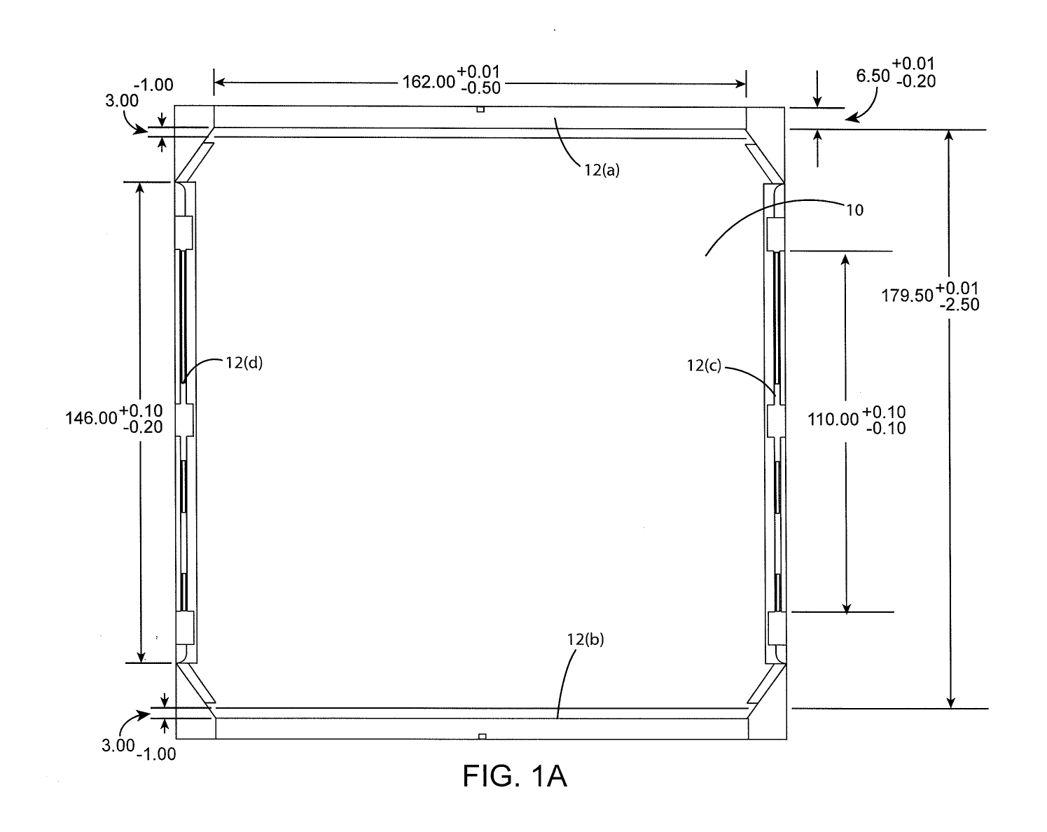

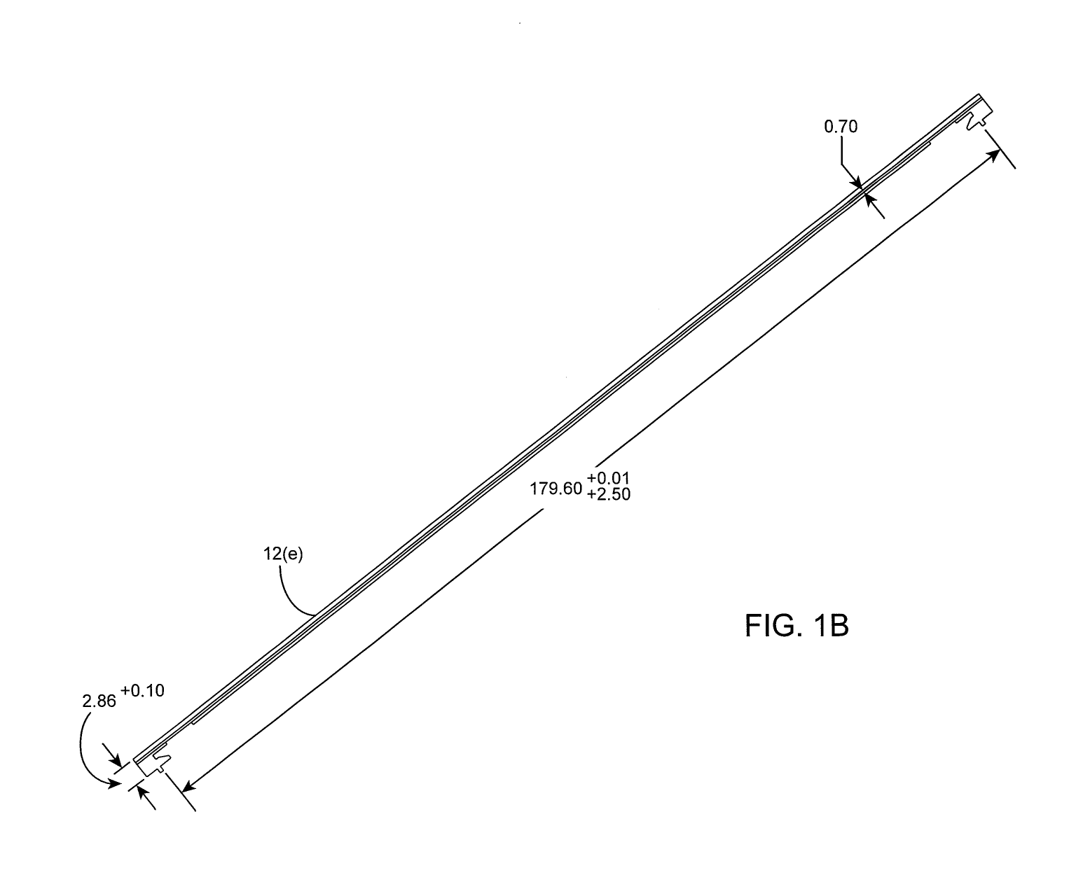

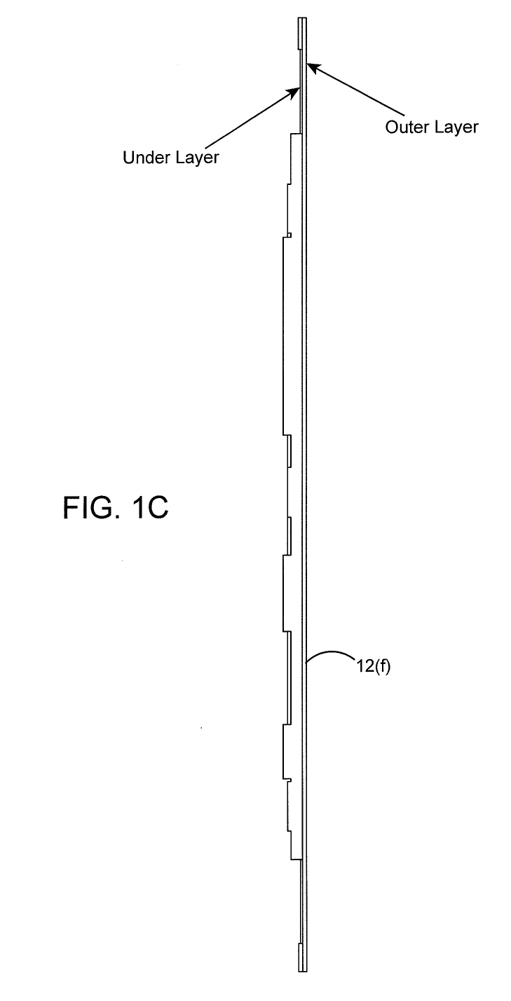

FIG. 1A shows a flat version drawing of a fabric subassembly according to an embodiment of the invention. The dimensions shown are for exemplary purposes, it is understood that embodiments of the invention can have different dimensions (e.g., longer or shorter dimensions, etc.). Likewise, for exemplary purposes a rectangular shape is shown, it is understood that different shapes may be used depending on the shape desired for the final product (e.g., triangular shape, square shape, etc.). A fabric portion 10 is shown with a frame strip 12(a)-12(d) adhered to each edge of the fabric portion 10. The frame strips 12(a)-12(d) may be made of a plastic substrate or spring steel, etc. The frame strips 12(a)-12(d) may be adhered to the fabric portion 10 by any commonly known method (e.g., glued, bonded, polyurethane casting, injection molding frame strips directly onto fabric, etc.). Frame strips 12(a) and 12(b) may be one type of frame strip and frame strips 12(c) and 12(d) may be a second type of frame strips. For example, frame strips 12(a) and 12(b) may be the frame strip 12(e) shown in FIG. 1B. The frame strip 12(e) shown in FIG. 1B may be made of clear plastic. In another example, frame strips 12(c) and 12(d) may be the frame strip 12(f) shown in FIG. 1C.

The fabric portion 10 may be any fabric or flexible material. For speaker related applications the fabric portion 10 is generally acoustically transparent to allow sound to pass through the fabric. Preferably the fabric portion 10 would not decrease any acoustic performance, or at least allow for as little sound reduction as possible. A positive tactile feedback of the fabric portion 10 may also be important for the user experience. It may be better to have fabric that does not feel too sharp or too metallic or too soft. The fabric portion 10 may be configured to be wrapped around a component housing such as a cylindrical shaped speaker housing. The fabric portion 10 may be configured to wrap around the entire speaker housing to substantially cover the entire speaker housing. The fabric portion 10 may be one single piece of fabric. The fabric portion 10 may be configured to cover a non-planar area.

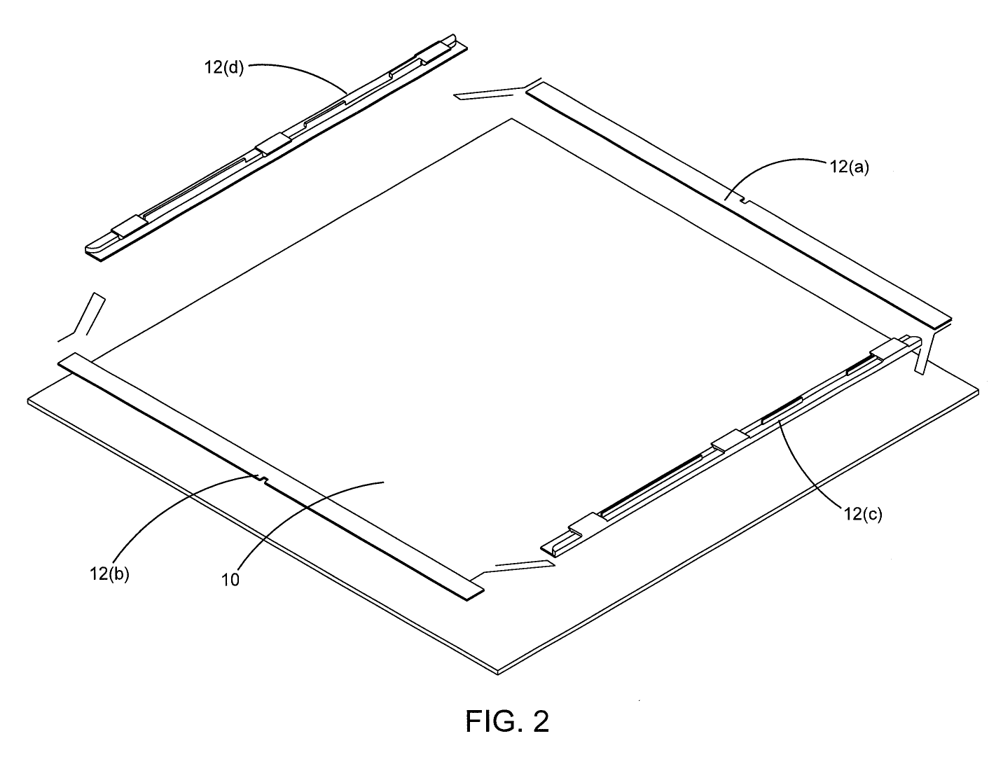

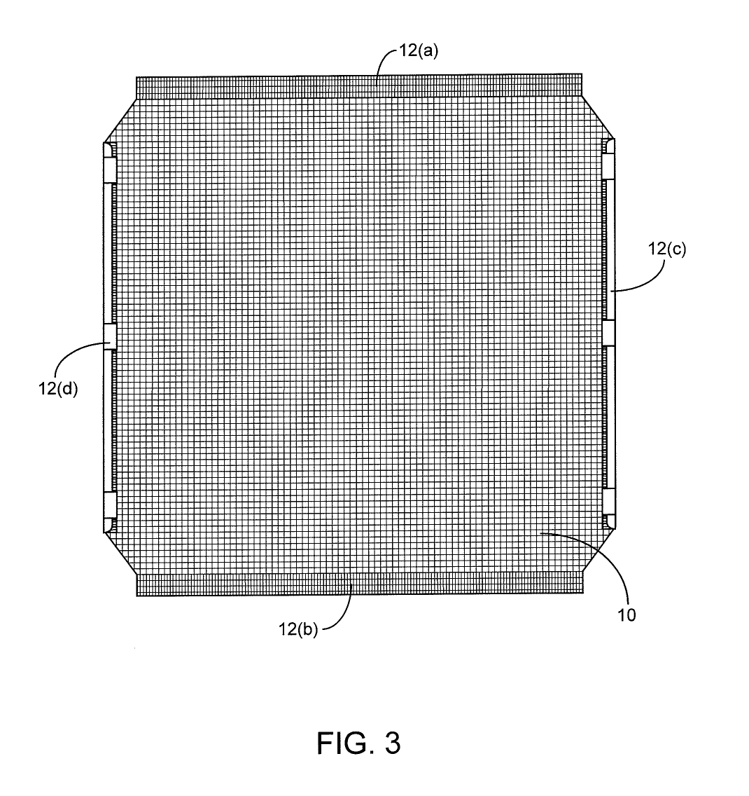

FIG. 2 shows how the frame strips 12(a)-12(d) are placed on the fabric portion 10. As explained above, the frame strips 12(a)-12(d) may be adhered to the fabric portion 10 in any commonly known manner. FIG. 3 shows the frame strips 12(a)-12(d) adhered to the fabric portion 10. The process of adhering the frame strips 12(a)-12(d) onto the fabric portion 10 may be automated or manual. In one embodiment the frame strips 12(a)-12(d) may be six millimeters in width, as an example, other sizes may be used.

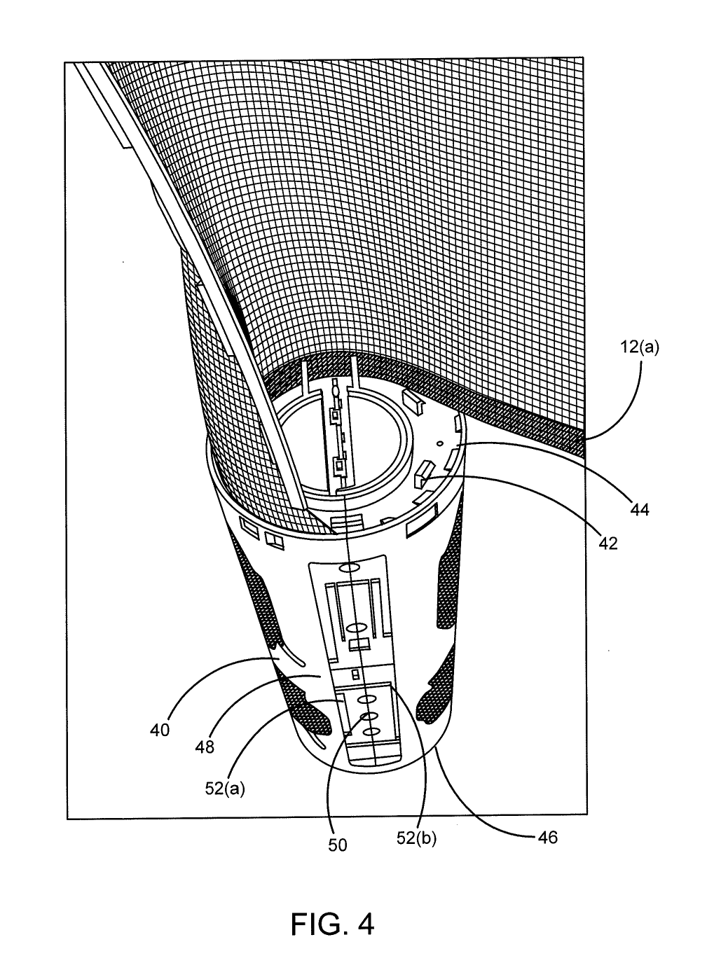

The fabric portion 10 with the adhered frame strips 12(a)-12(d) may be used to cover a speaker housing as shown in FIGS. 4-13. The speaker housing may be comprised of a plastic substrate. The speaker housing may be configured to house speaker components therein. The speaker components may be positioned substantially within the housing. Exemplary speaker components may include at least one driver, control circuitry, connectivity circuitry, and a power source. One or more of the speaker components may be external to the housing. The power source may include a battery, and/or circuitry to connect to an external power source (e.g., an electric outlet). The driver can refer to a device that converts electrical signals from an electrical source into sound for a listener. The speaker components may optionally include a microphone.

As shown in FIG. 4 the speaker housing 40 may be a cylinder shape, however, it is understood that other shapes may be used as desired (e.g., triangular shape, rectangular shape, square shape, etc.). The speaker housing 40 may comprise a first end 42 comprising a first fastening mechanism (e.g., shoulder 44) that goes around the edge of the first end 42. The speaker housing 40 may comprise a second end 46 comprising a second fastening mechanism (e.g., shoulder 54 (not shown)) that goes around the edge of the second end 46.

The speaker housing 40 may also comprise a main body 48 comprising a recess 50 and a first main body fastening mechanism (e.g., shoulder 52(a)) and a second main body fastening mechanism (e.g., shoulder 52(b)).

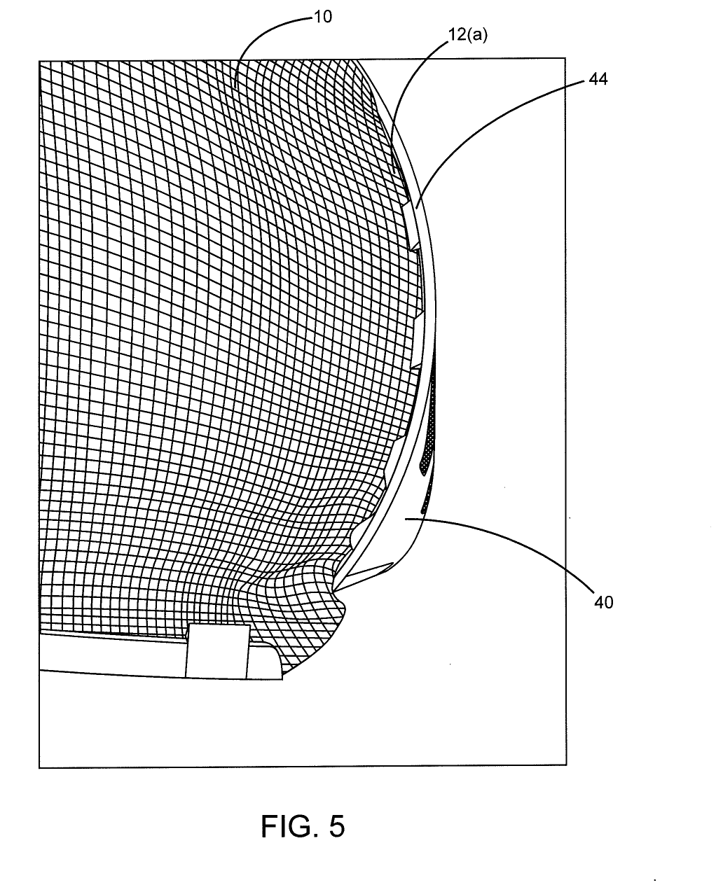

After adhering the frame strips 12(a)-12(d) to the fabric portion 10, the fabric portion 10 may be assembled onto the speaker housing 40. As shown in FIG. 4, a first frame strip 12(a) may be placed or tucked under the shoulder 44 on a first end 42 of the speaker housing 40. The first frame strip 12(a) may be placed or tucked all the way around the shoulder 44 on the first end 42 of the speaker housing 40 in a single motion or in stages. A close up of this is shown in FIG. 5.

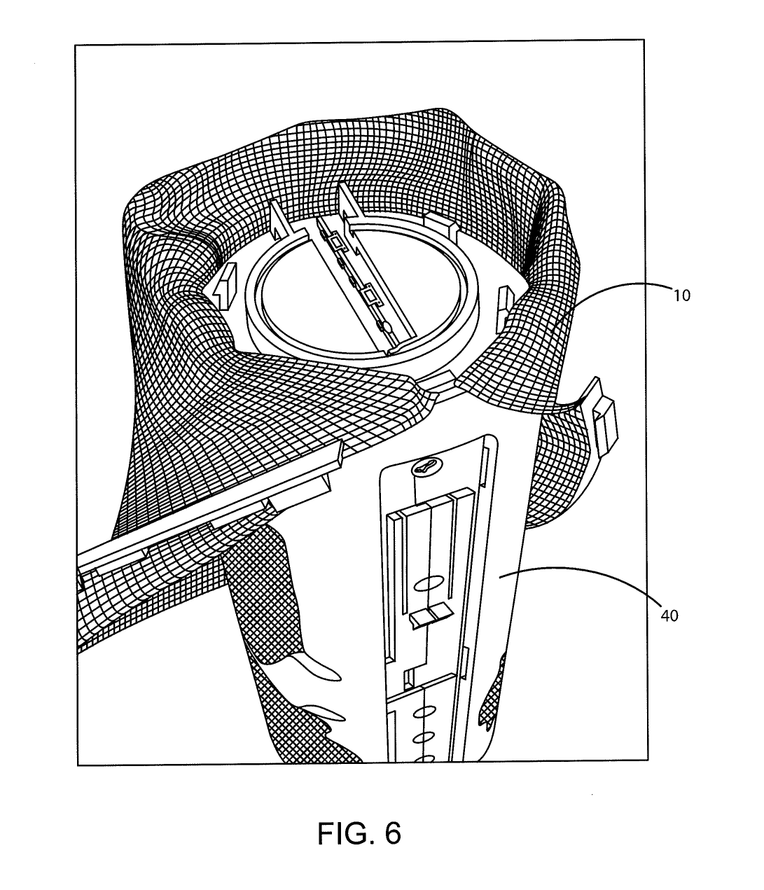

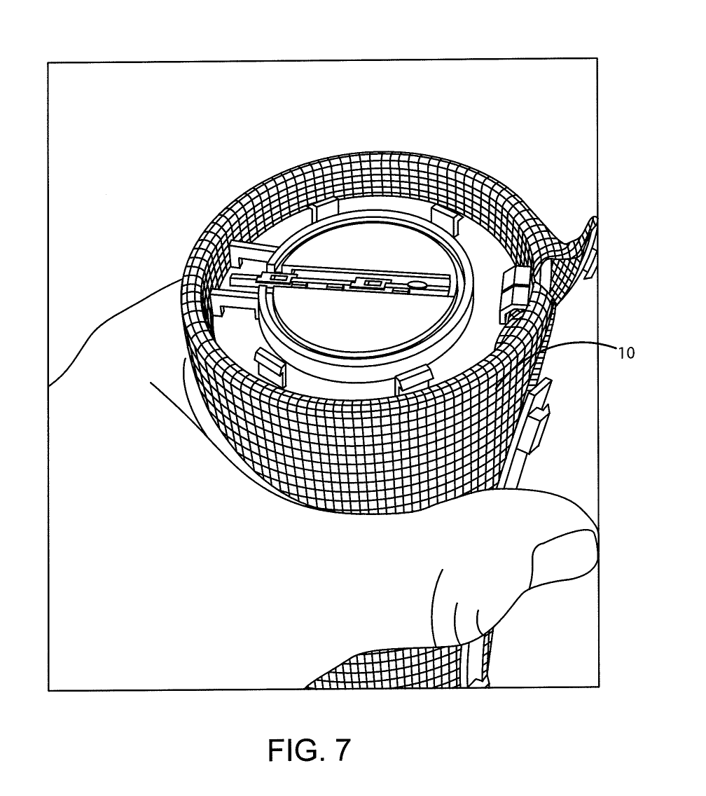

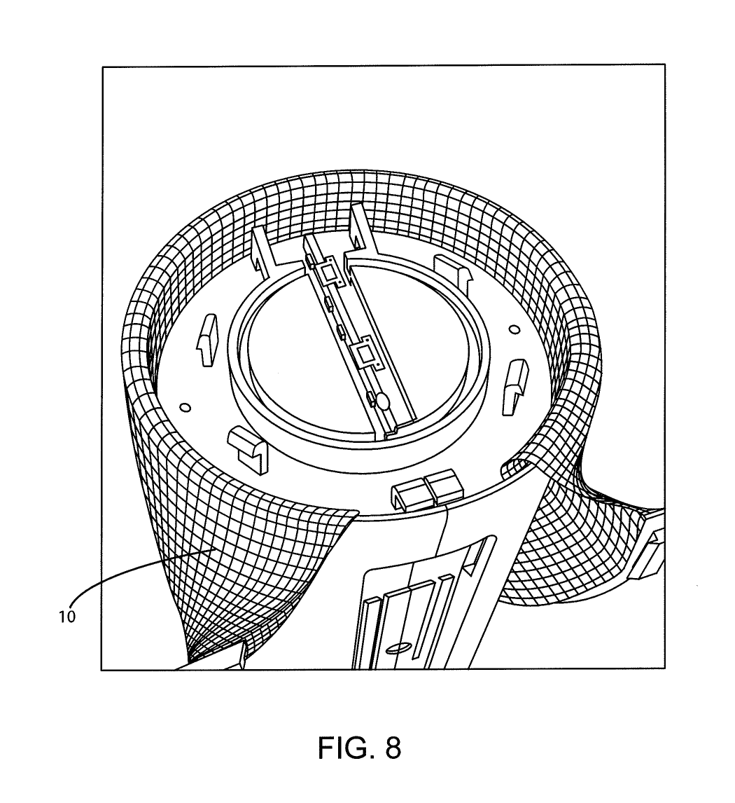

As shown in FIG. 6, the fabric portion 10 may then be laid over the speaker housing 40. The fabric portion 10 may then be pulled down towards a second end of the speaker housing 40 as shown in FIG. 7 and FIG. 8.

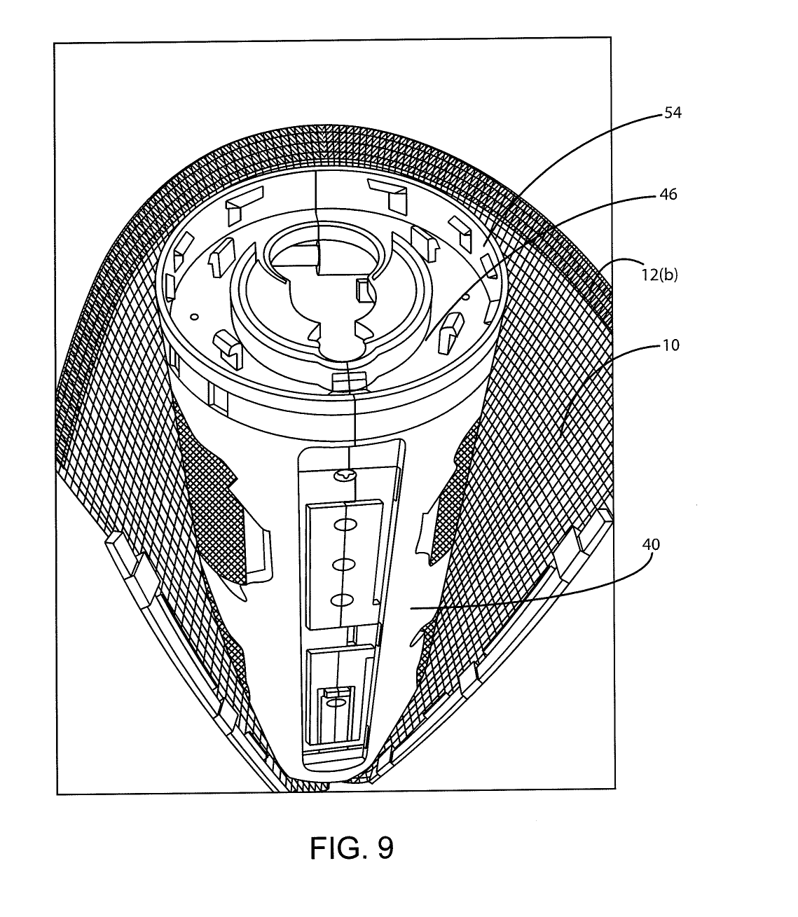

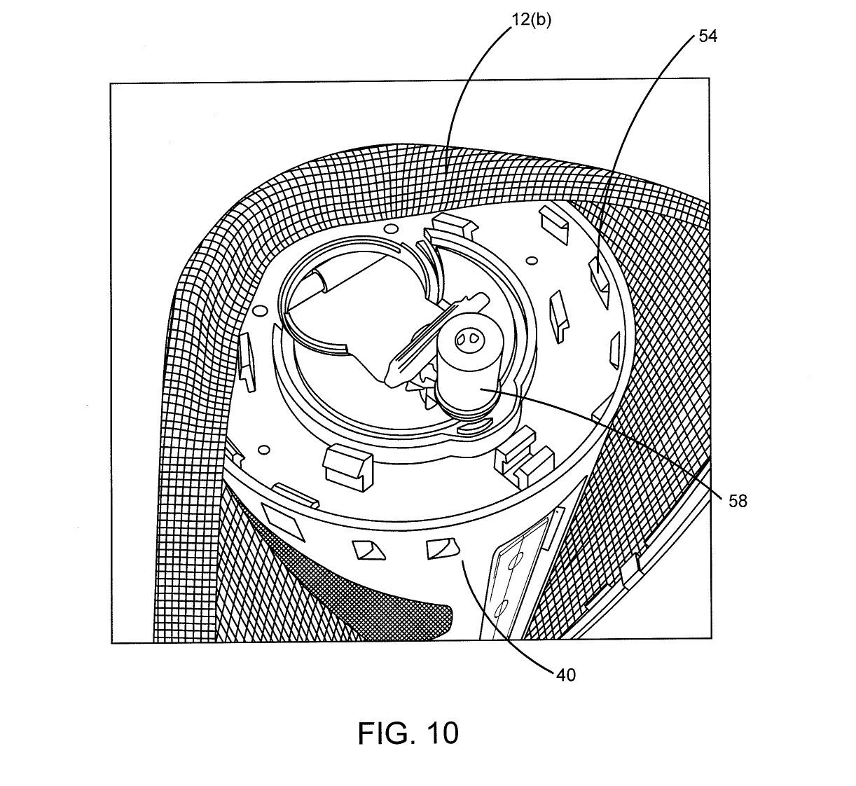

The speaker housing 40 may then be rotated to do the second end 46 of the speaker housing 40, as shown in FIG. 9. In some embodiments the speaker housing 40 may be aligned in other orientations during the application of the fabric portion 10. As shown in FIG. 10, the second frame strip 12(b) may be placed or tucked into the shoulder 54 on the second end 46 of the speaker housing 40. The second frame strip 12(b) may be placed or tucked all the way around the shoulder 54 on the second end 46 of the speaker housing 40. The second end 46 of the speaker housing 40 may contain a cavity to hold a battery 58. The battery, or other components stored in the end portions of the speaker housing 40, may be left out to allow for easier assembly of fabric on the second end 46 of the speaker housing 40. Similar components may be stored in the first end 42 of the speaker housing 40.

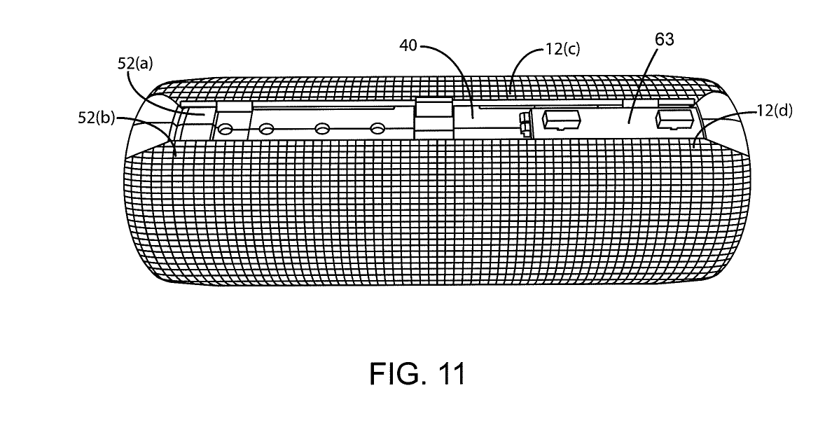

Next, the third frame strip 12(c) and the fourth frame strip 12(d) may be each placed or snapped into the speaker housing 40 as shown in FIG. 11. The third frame strip 12(c) may be placed under or snapped into a first main body shoulder 52(a) and the fourth frame strip 12(d) may be placed under or snapped into a second main body shoulder 52(b). An insert 63 may be placed on the main body 40. The insert 63 may include two raised buttons to include controls such as buttons for volume control.

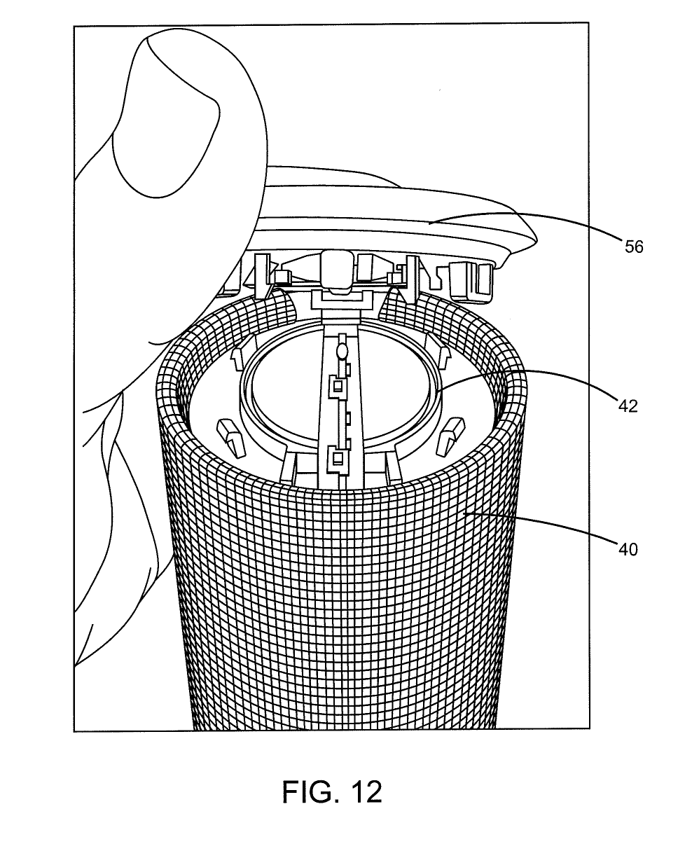

A cover piece or cap may then be placed in the recess to cover the edges (not shown). A cover piece or cap 56 may then be placed on each of the first end 42 and second end 46 of the speaker housing 40, as shown in FIG. 12. Once everything is tucked in, the tension of the fabric portion 10 prevents the fabric from coming off of the speaker housing 40. The cover pieces or caps are used to cover the edge, and they may operate to retain the cover strips in their desired positions.

Controls, connectors, and/or interfaces may be provided on one or more of the cover pieces or caps. Exemplary controls may include volume, power, etc. Exemplary connectors may include an interface to plug in a power cable, an interface to plug in a portable device such as an audio source device (e.g., MP3 player, smart phone, laptop, touch pad, computer, etc.). A display may also be provided on one or more of the cover pieces.

Accordingly an end product may be a speaker comprising a speaker housing for housing speaker components therein. The speaker housing may comprise a first end comprising a first fastening mechanism (e.g., shoulder) and a second end comprising a second fastening mechanism (e.g., shoulder). The speaker housing may further comprise a main body coupled with the first end and the second end, the main body comprising a first main body fastening mechanism (e.g., shoulder) and a second main body fastening mechanism (e.g., shoulder). A fabric portion may be coupled with the speaker housing, the fabric portion comprising a first edge, a second edge, a third edge, and a fourth edge. The fabric portion may further comprise a first frame strip coupled with the first edge, a second frame strip coupled with the second edge, a third frame strip coupled with the third edge, and a fourth frame strip coupled with the fourth edge. The fabric portion may coupled with the speaker housing via the first frame strip of the fabric portion and the first fastening mechanism (e.g., shoulder) of the speaker housing, the second frame strip of the fabric portion and the second fastening mechanism (e.g., shoulder) of the speaker housing, the third frame strip of the fabric portion and the first main body fastening mechanism (e.g., shoulder) of the speaker housing, and the fourth frame strip of the fabric portion and the second main body fastening mechanism (e.g., shoulder) of the speaker housing.

The fabric portion of the speaker may be under tension in multiple directions due to the fabric portion being coupled with the speaker housing. For example, the fabric portion of the speaker may be under tension in multiple directions due to the fabric portion being coupled with the speaker housing via the first frame strip of the fabric portion and the first shoulder of the speaker housing, the second frame strip of the fabric portion and the second shoulder of the speaker housing, the third frame strip of the fabric portion and the first main body shoulder of the speaker housing, and the fourth frame strip of the fabric portion and the second main body shoulder of the speaker housing. The fastening mechanism may allow stretching of the fabric portion when coupled with the speaker to apply tension to the fabric portion.

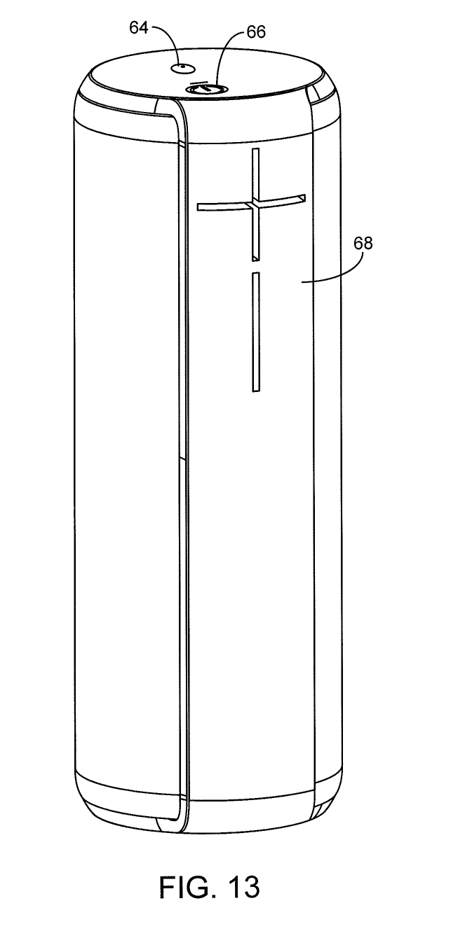

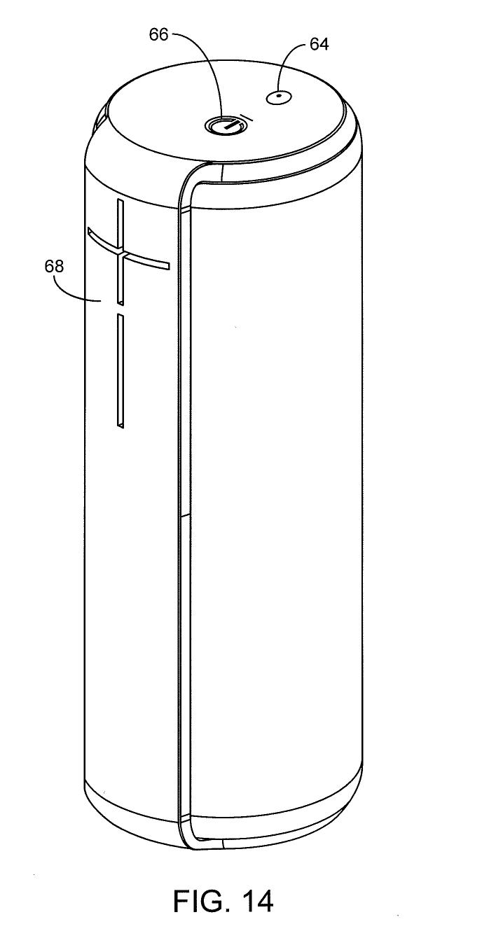

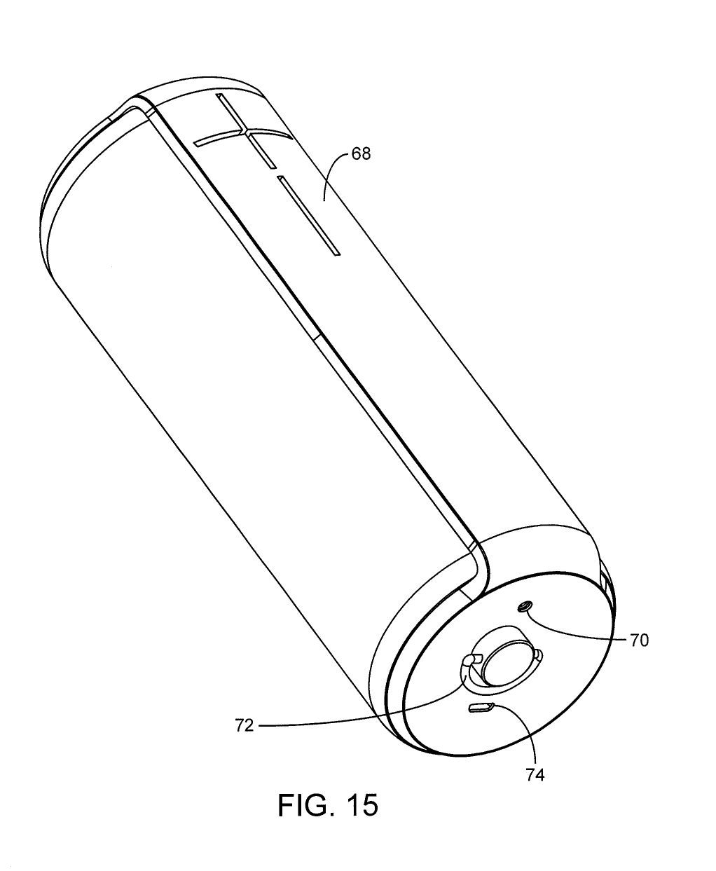

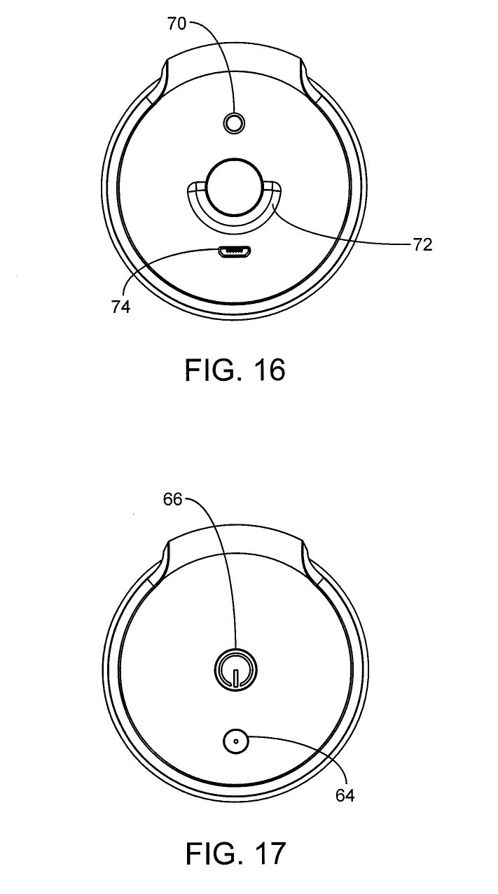

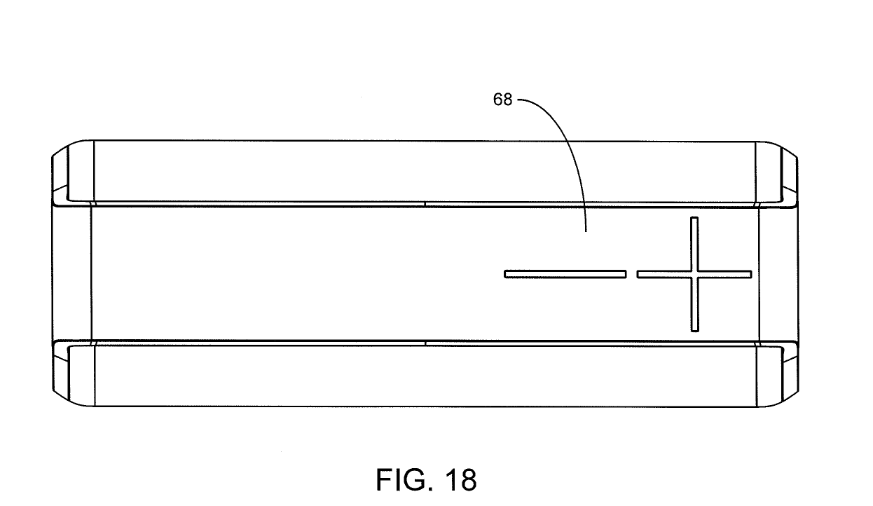

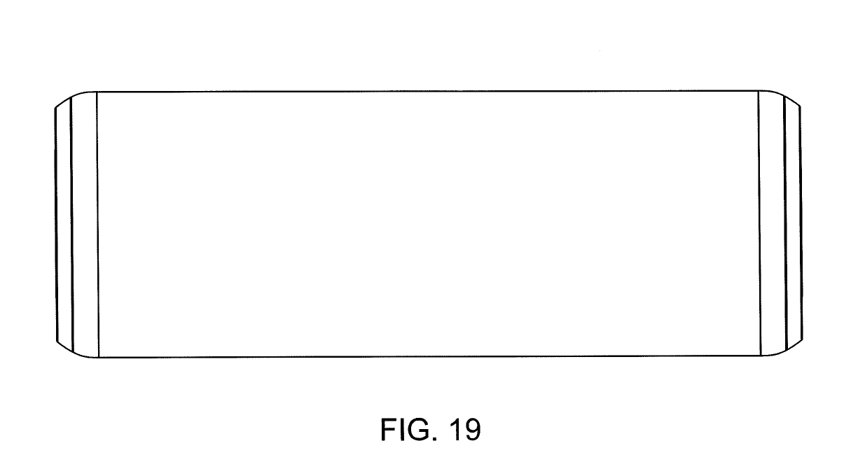

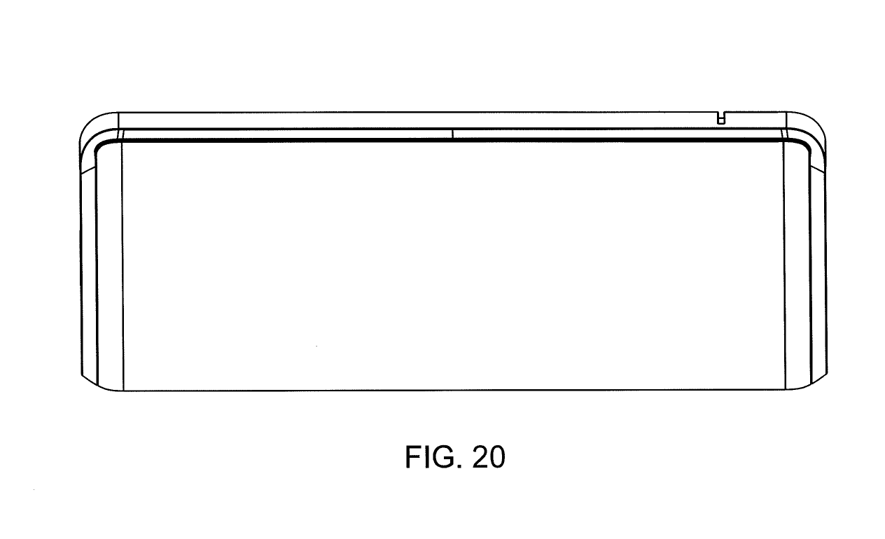

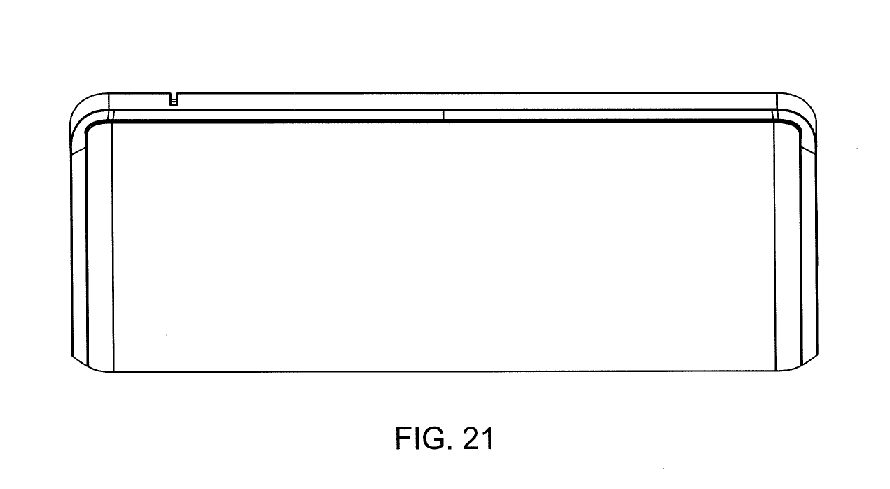

An exemplary end product is shown in FIGS. 13-21. FIG. 13 shows a perspective view of a covered housing in the form of a speaker. The speaker may include a button 64, a button 66 and controls 68. FIG. 14 shows another view of a speaker. The speaker may include a button 64, a button 66 and controls 68. FIG. 15 shows another view of a speaker. The speaker may include controls 68, a jack 70, a D-ring 72 and an input port 74. FIG. 16 shows a bottom view of a speaker. The speaker may include a jack 70, a D-ring 72 and an input port 74. FIG. 17 shows a top view of a speaker. The speaker may include a button 64 and a button 66. FIG. 18 shows a front view of a speaker. The speaker may include controls 68. FIG. 19 shows a back view of a speaker. FIG. 20 shows a right view of a speaker. FIG. 21 shows a left view of a speaker.

Embodiments of the invention provide for a number of advantages. For example, embodiments are particularly advantageous for cylindrical shaped components because it is difficult to create tension in the x-y direction (tension both vertically and horizontally around the cylindrical shaped component) for a cylindrical shape. One big challenge is to control the fabric tension in x-y direction after fabric is assembled to a cylindrical shape. The tension needs to be high enough so that the fabric cannot simply be pulled off the cylindrical shape. Accordingly, a traditional sock assembly where a fabric sock that is open on both ends is slipped over a rectangular or cylinder shape would not work because the tension of the sock cannot be well controlled. For example, since a sock can only be clamped at the open ends, it does not allow control of the tension in the other direction (e.g., the sock may either hang loose or bow in). Moreover, using a traditional sock assembly may require a cap on each end with a plastic piece to secure the sock in place. This may not allow for additional features or controls (e.g., buttons, etc.) or connectors on the ends of the speaker housing because of the constrained space due to the mechanism used to secure the sock in place. This may be especially an issue with portable-type speakers that have limited space for controls. Embodiments of the invention create tension in the x-y direction so that frame strips bonded to the fabric that are tucked under shoulders of a speaker housing. Once the fabric strips are secured under the shoulders, the fabric does not pop out of place thereby holding the fabric in the intended position and shape. Thus, the fabric assembly creates tension such that the fabric is held into place on the housing.

Moreover, since a cap is not required on each end to hold the fabric in place, the spaces on each end can be utilized for controls, connectors and other features. This is particularly advantageous with small portable speakers which have limited space for controls.

In another example of advantages, embodiments of the invention also allow for one piece of fabric to cover the housing without any visible wrinkles. This makes assembly and manufacturing easier and cost effective and also allows for a nice looking product since only fabric on the outside of the housing is visible, without any seams or wrinkles.

The foregoing description is intended to be illustrative, but not limiting, of the scope of the invention which is set forth in the following claims. As can be understood by those of skill in the art, the present invention may be embodied in other specific forms without departing from the essential characteristics thereof.

What is claimed is:

1. A process for assembly of a covered housing comprising:
placing a first frame strip coupled with a fabric portion, under a shoulder on a first end of a housing;
pulling the fabric portion toward a second end of a housing;
placing a second frame strip coupled with the fabric portion, under a shoulder on the second end of the housing;
placing a third frame strip coupled with the fabric portion, under a first main body shoulder of the housing; and
placing a fourth frame strip coupled with the fabric portion, under a second main body shoulder of the housing.

2. The process of claim 1 wherein the first frame strip is placed all the way around the shoulder on the first end of the housing.

3. The process of claim 1 wherein the second frame strip is placed all the way around the shoulder on the second end of the housing.

4. The process of claim 1 further comprising placing a first cover piece on the first end of the housing and a second cover piece on the second end of the speaker housing.

5. The process of claim 1 further comprising placing a third cover piece in a recess on a main body of the housing.

6. The process of claim 1 wherein the first frame strip placed under the shoulder on the first end of the housing, the second frame strip placed under the shoulder on the second end of the housing, the third frame strip placed under the first main body shoulder of the housing, and the fourth frame strip placed under the second main body shoulder of the housing, create tension such that the fabric portion will be held into place.

7. The process of claim 4 wherein the first cover includes at least one control for a speaker.

8. The process of claim 4 wherein the first cover includes at least one connector.

9. The process of claim 1 wherein the fabric portion is acoustically transparent.

10. The process of claim 1 wherein the fabric portion has a positive tactile feedback.

11. The process of claim 1 further comprising adhering each of the frame strips to an edge of the fabric portion.

12. A speaker comprising:
a speaker housing for housing speaker components therein;
the speaker housing comprising a first end comprising a first shoulder;
the speaker housing further comprising a second end comprising a second shoulder;
the speaker housing further comprising a main body coupled with the first end and the second end, the main body comprising a first main body shoulder and a second main body shoulder;
a fabric portion coupled with the speaker housing, the fabric portion comprising a first edge, a second edge, a third edge, and a fourth edge;
the fabric portion further comprising a first frame strip coupled with the first edge, a second frame strip coupled with the second edge, a third frame strip coupled with the third edge, and a fourth frame strip coupled with the fourth edge; and
the fabric portion coupled with the speaker housing via the first frame strip of the fabric portion and the first shoulder of the speaker housing, the second frame strip of the fabric portion and the second shoulder of the speaker housing, the third frame strip of the fabric portion and the first main body shoulder of the speaker housing, and the fourth frame strip of the fabric portion and the second main body shoulder of the speaker housing.

13. The speaker of claim 12 wherein the speaker components comprise at least one driver, control circuitry, connectivity circuitry and a power source.

14. The speaker of claim 12 further comprising a first cover piece coupled with the first end of the speaker housing.

15. The speaker of claim 12 further comprising a second cover piece coupled with the second end of the speaker housing.

16. The speaker of claim 12 wherein the speaker housing further comprises a recess.

17. The speaker of claim 16 further comprising a third cover piece coupled with the recess of the speaker housing.

18. The speaker of claim 14 wherein the first cover piece includes at least one control for the speaker.

19. The speaker of claim 14 wherein the first cover piece includes at least one connector or interface.

20. The speaker of claim 12 wherein the fabric portion is a single piece of fabric.

21. The speaker of claim 12 wherein the fabric portion is under tension in multiple directions due to the fabric portion being coupled with the speaker housing via the first frame strip of the fabric portion and the first shoulder of the speaker housing, the second frame strip of the fabric portion and the second shoulder of the speaker housing, the third frame strip of the fabric portion and the first main body shoulder of the speaker housing, and the fourth frame strip of the fabric portion and the second main body shoulder of the speaker housing.

22. The speaker of claim 12 wherein the fabric portion covers a non-planar area.

23. The speaker of claim 12 wherein the speaker is cylindrical.

24. The speaker of claim 12 wherein the first frame strip, the second frame strip, the third frame strip and the fourth frame strip are glued to the fabric portion.

25. A speaker comprising:
a speaker housing for housing speaker components therein;
the speaker housing comprising a first end comprising a first fastening mechanism;
the speaker housing further comprising a second end comprising a second fastening mechanism;
the speaker housing further comprising a main body coupled with the first end and the second end, the main body comprising a first main body fastening mechanism and a second main body fastening mechanism;
a fabric portion coupled with the speaker housing, the fabric portion comprising a first edge, a second edge, a third edge, and a fourth edge;
the fabric portion further comprising a first frame strip coupled with the first edge, a second frame strip coupled with the second edge, a third frame strip coupled with the third edge, and a fourth frame strip coupled with the fourth edge; and
the fabric portion coupled with the speaker housing via the first frame strip of the fabric portion and the first fastening mechanism of the speaker housing, the second frame strip of the fabric portion and the second fastening mechanism of the speaker housing, the third frame strip of the fabric portion and the first main body fastening mechanism of the speaker housing, and the fourth frame strip of the fabric portion and the second main body fastening mechanism of the speaker housing.

26. The speaker of claim 25 wherein the fastening mechanism allows stretching of the fabric portion when coupled with the speaker housing to apply tension to the fabric portion.
